(19) United States
(12) Patent Application Publication
(10) Pub. No.: US 2022/0340422 A1
(43) Pub. Date: Oct. 27, 2022

(54) SEPARATION OF A STRONG ACID FROM ITS SALTS

(71) Applicant: Recreo Pharmaceuticals LLC, Jerusalem (IL)

(72) Inventor: Asher VITNER, Jerusalem (IL)

(21) Appl. No.: 17/641,091

(22) PCT Filed: Sep. 16, 2020
(86) PCT No.: PCT/IL2020/051014

§ 371 Date: Mar. 7, 2022

Related U.S. Application Data
(60) Provisional application No. 62/900,707, filed on Sep. 16, 2019.

(51) Int. Cl. C01B 7/03

(52) U.S. Cl. CPC C01B 7/035

(57) ABSTRACT

The present invention relates to a process for the separation of strong acid from its salts. In said process, a strong acid salt is reacted with organic weak base (OWB) in the presence of a hydrophilic solvent and CO₂. The cation of the strong acid salt is precipitated to produce a carbonate/bicarbonate salt and the strong acid form a liquid salt with the OWB. The above process is performed in a solution comprising both the strong acid salt and the WBO. In the next step, the strong acid is released from its OWB liquid salt and the OWB is returned to a previous step.

### FIELD OF THE INVENTION

The present invention relates to a novel process for the regeneration of a strong acid, which in turn may be to react same with solids resulting in the production of salts of strong acids, from the salts of the solids. The process yields, in some aspects, a carbonate salt and the free acid. The resulting strong acid obtained in this process is recycled to the step in which it is reacted with the solids.

### BACKGROUND OF THE INVENTION

Strong acid salts are produced as by-products in numerous industrial processes. In many cases, the produced salts exit the production plants as waste. The waste needs to be disposed of and such removal results in the contamination of the environment. The present invention provides a cheap process in which the strong acid can be produced from its salt and recycled.

Mining Industry—Ores are used for the extraction of metal cationic products. The leaching products contain also a variety of other cations. Strong acids are used in the leaching process and salts of those cations are produced as waste. The present invention gives a way to reduce the amount of the waste while recycling the acid to the ore leaching step.

The present invention enables a process for the reducing of the volume of fly-ash to be disposed of while extracting valuable products from the fly ash and recycling the acid used for leaching.

In other processes in the chemical and biotechnological industry acids and/or bases are added and waste salts are produced. The present invention gives a way to reduce the amount of this waste and reuse the acid and or base.

The increase in CO₂ level in the atmosphere has a significant contribution to the global warming problem. The present invention gives a method for the fixation of CO₂ as a carbonate salt thus reducing both air pollution and environmental pollution.

Processes have been suggested to separate weak acids from their salts to obtain the free weak acid:

Baniel (U.S. Pat. No. 5,510,526) demonstrated splitting sodium lactate (a weak acid) and forming sodium bicarbonate as the conjugated base. Baniel found a way to efficiently combine tri-alkyl amine several driving forces to enable his process; thermal energy, the (chemical) crystallization energy of NaHCO, the (chemical energy) of high reagent concentration, the (mechanical) energy of C02 pressurization and the thermal sensitivity of carboxylic acid extraction (U.S. Pat. No. 4,275,234).

Several patents demonstrated the extraction of free HCl from diluted solutions and for the later recovery of concentrated HCl by stripping of the amine:

It has been demonstrated that HCl can be extracted from its acid solution using the Weak base extractant TEHA (Tri ethyl hexyl amine) (Baniel and Jansen, US patent application No. 2012/0134912; Baniel and Eyal, US patent application No. 2010/0093995, US patent application No. 2011/0028710 and EP 2 321 218 A1; Baniel, Eyal and Jansen, WO 2010/064229 A2; Coenen, Kosswig, Hentschel and Ziebarth, U.S. Pat. No. 4,230,681; Willi Ziegenbein, Ferdinand von Praun, U.S. Pat. No. 4,272,502 A; DeVries, U.S. Pat. No. 4,640,831 A). The extracted HCl is released from TEHA by heating the loaded extractant at 140° C.-170° C. to yield an HCl gas of low vapor pressure or by back extraction to yield an HCl solution. This process can be used only on separation of free strong acid but not on a salt of a strong acid.

Asuncion Aranda (CA2973558A1) has demonstrated that in the presence of CO₂, CaCl₂ can be split by TOA (Tri octyl amine) which is a medium strength base, to give CaCO₃ and TOA*HCl. Since TOA is a too strong base, it holds strongly the strong acid and therefore, back-rxtraction of the extracted strong acid gives a very dilute HCl solution. One means to overcome this difficulty may be to wash the extracted HCl with a base, or to use weaker amine extractants such as TEHA to extract HCl from CaCl₂ although this has not been demonstrated, and instant inventors efforts trying same yielded negative results.

Thus, an efficient means to minimize waste and the ability recycle strong acids remains an elusive goal.

### SUMMARY OF THE INVENTION

It was surprisingly found herein that a strong acid can be separated from its salts in an organic phase comprising a hydrophilic solvent, OWB and the strong acid salt, in the presence of CO₂. A carbonate/bicarbonate salt is produced and the acid remains in solution. The removal of the solvent from the organic phase enables the release of the free acid from the resulting solvent-free organic phase to give the free acid at reasonable concentrations (at above 0.1 M).

The term “strong acid” as referred to herein, refers to an acid having at least one acid group with a pK of less than 2.

In some aspects, reference to the term “strong acid” may be interchangeably referred to as “HCl”, which may be generalized to refer to any strong acid and should not be taken to be limited only to hydrochloric acid. Similarly, reference to the term “strong acid salt” may be generalized to refer to “MCl₂”, which may include, but is not limited to reference only to metal chloride salts.

Thus it is clear that the invention contemplates the use of many strong acids and strong acid salts.

In some aspects of the invention, an MCl₂ waste solution can be converted to MCO₃ and HCl, as described by the following equations:

OWB+MCl₂+CO₂====OWB*HCl+MCO₃ Eq. 1

OWB*HCl OWB+HCl Eq. 2

Wherein, the term “OWB” refers to an organic weak base.

It will be understood that reference to the term “weak base” as used herein is to encompass any base having a pK½ of less than 1.5.

It will also be understood that reference to the term “pK½” as used herein is to encompass the pH in an aqueous phase that is in contact with a phase comprising OWB*HCl and OWB at OWB*HCl/(OWB+OWB*HCl) of 0.5.

To date, there are limited means to split a salt comprising a strong acid, which involve splitting same using very high temperatures, or using electrical energy via electro dialysis.

Surprisingly, in the instant invention, the splitting could be readily accomplished using an OWB and CO₂.

The processes of this invention can, in some embodiments, be used for the assimilation of CO₂ in carbonate salts during splitting of strong acid salts into the acid and a conjugated base (wherein bicarbonate and carbonate are considered here also as base). In some aspects, the development of the instant processes answers an urgent need in many industries, including, in some aspects the important reduction of the amount of waste produced from industry.

The state of the art led to the conclusion that that no solvent extraction process using an organic base can extract a strong acid from its salt and efficiently release the strong acid. Furthermore, to date, the state of the art leads to the conclusion that achieving both the extraction of a strong acid from its salt, in the presence of CO₂ and releasing the acid to yield a high enough concentration of same so as to be industrially applicable is not possible.

Yet, against this backdrop, surprisingly, in the instant application, a novel approach was developed in order to enable both efficient extraction of a strong acid from its salts, in the presence of CO₂, and the release of the strong acid from the basic extractant to yield a product of high enough concentration.

In the present method the salt split is performed by using a formulation comprising an OWB, that shifts up its basicity, following by step to drastically reduce the basicity of a weak organic base and release of the strong acid from the amine.

For Example, as described in the following equation, Step a may include:

OWB+MX+water+CO₂======OWB*HX+M-carbonate or M-bicarbonate Eq. 3

Wherein:

OWB is an organic weak base;

HX is a strong acid having at least one proton with pK½ lower than 1.5; and

MX is a salt of strong acid; and

In Step b—the reduction of the basicity of amine and back extraction occurs as follows:

OWB*HX======OWB+HX Eq. 4

It was found that in the addition of a hydrophilic solvent can assist in forming a reaction mixture in which both OWB, OWB*HCl a salt of strong acid salt and water.

Combining the reactants, OWB and the salt in the same phase, induces the increase in the basicity of the OWB, and enables the reaction describes in Eq 3.

The presence of such a liquid phase (comprising both the salt and the OWB is essential for performing the reaction in Eq. 3.

Additional liquid phases such as a hydrophilic aqueous phase and/or a hydrophobic phase comprising OWB might be also present, but are not necessarily essential for the process.

In the next step HX should be released from OBE*HX. In order to enable this step, one or more of the following operations or the combination of the following operations must be performed:
1—Removing the hydrophilic solvent (for example by distillation);
2—Addition of an hydrophobic solvent to induce separation of a phase comprising the hydrophilic solvent;
3—Removing of water (for example, by distillation);
4—Addition of water and inducing Back extraction;
5—Other methods inducing separation of the acid from the amine.

The aim of operation in equations 1-3 is to shift the PK½ of the OWB from that of Stronger Base (as in Step 1) to a much weaker base and as a result decreasing the bond strength between OWB and the strong acid. One of the most important achievements of this patent is finding a way to remove the hydrophilic solvent from the reaction phase by minor change in composition and/or conditions.

The processes and methods of this invention may be incorporated in a variety of applications, enabling environmentally friendly processes, for reducing the volume of inorganic waste and preservation of raw materials (acid and bases). The processes and methods of this invention may find application in a variety of fields, including, inter alia, mining, Fly ash treatment, inorganic chemistry, biotechnology and processes in industrial chemistry and others, as will be appreciated by the skilled artisan.

### DETAILED DESCRIPTION OF THE INVENTION

As described herein, it has surprisingly been found that strong acids can be separated from their strong acid salts by performing the reaction in an organic phase comprised of a hydrophilic solvent, OWB and the strong acid salt, in the presence of CO₂.

Therefore, in some embodiments, this invention provides a process for the recovery of a strong acid from its salt with monovalent or divalent cation comprising the steps:
a) Preparing a reaction mixture comprising a first liquid phase comprising of (a) at least one organic weak base (OWB), (b) at least one hydrophilic solvent and (c) a salt of a strong acid.
b) Adding CO₂ into said solution inducing the precipitation of carbonate salt or bicarbonate salt or the combination of.
c) Removing of at least part of the resulting suspension comprising the liquid phase and separation of the precipitated carbonate salt, to get the resulting solution and the carbonate salt or the bicarbonate salt.
d) Separation of the hydrophilic solvent from said resulting solution and recycling of the hydrophilic solvent to step 1.
e) Separation of the strong acid from the OWB and recycling the OWB to step 1.

In some embodiments, the reaction mixture comprise a single liquid phase. In another embodiment the reaction mixture comprises 2 liquid phases, or in another embodiment, the reaction mixture comprises 3 liquid phases. In some embodiments, according to this aspect, the second liquid phase, which is an aqueous liquid phase, comprises (a) a salt of a strong acid, (b) water and (c) at least one hydrophilic solvent, or a third liquid phase, which is a hydrophobic liquid phase comprising at least one organic weak base (OWB). In another embodiment, the reaction mixture comprises a solid phase comprising a strong acid salt, in addition to one or two or 3 liquid phases.

In some embodiments, the reaction proceeds better with increases in the concentration of the strong acid salt. In some embodiments, the concentration of said salt of strong acid in said first liquid phase is at least 25% of its solubility limit concentration. In another embodiment the concentration of the salt of the strong acid in the first liquid phase is at least 50% of its solubility limit concentration.

In a further embodiment the weight ratio between the hydrophilic solvent/s to the OWB, in the first liquid phase, is higher than 0.2. In another embodiment the weight ratio between the hydrophilic solvent/s to the OWB, in the first liquid phase, is higher than 0.25.

In a further embodiment the weight ratio between the hydrophilic solvent/s to the OWB, in the first liquid phase, is higher than 0.6 and in another embodiment the weight ratio between the hydrophilic solvent/s to the OWB, in the first liquid phase, is higher than five.

In other embodiments, the strong acid has a pK½ of less than 1.5. In another embodiment the pK½ is lower than 1 and in another preferred embodiment the pK½ is less than 0.5.

In other embodiments the strong acid is one of a halogenic acid, sulfuric acid, nitric acid, sulfuric acid, phosphoric acid or any combination thereof.

In some embodiments, the cation of salt of strong acid is selected from the group comprising of monovalent cations or divalent cations and in some embodiments, the cation of salt of strong acid is sodium, ammonium or calcium or magnesium or a combination thereof.

In some embodiments, the strong acid salt is one of CaCl₂, NaCl or MgCl.

An hydrophilic solvent is an essential component in the reaction mixture.

The partition coefficient, abbreviated P, is defined as a particular ratio of the concentrations of a solute between two solvents. In the following, the two solvents are water and octanol. Log P is the logarithmic value of the distribution P between octanol to water (Log P(octanol/water)) and are measured at a specific temperature and pH.

In one embodiment, the Log P (octanol/water) of the hydrophilic solvent is less than 1.5.

In some embodiments, the hydrophilic solvent is selected from the group of C₁-C₄ alkanol, C₁-C₄ ester, polyols, polyol ethers, polyol esters, hydrophilic polar solvents and a combination thereof. In some embodiments, the hydrophilic solvent is selected from 1-propanol, iso butanol or third butanol or any combination thereof

### Solvent Split

The term “solvent split”, as referred to herein, in some embodiments, refers to the case in which a small change in conditions leads to a strong effect of formation of a second liquid phase comprising the hydrophilic solvent/s. The result of such phenomena is a significant reduction in the cost of separation of the hydrophilic solvent prior to the stage of acid release.

It was very surprisingly found that in cases in which the hydrophilic solvent has Log P(Octanol/water) with a value in the range of between (−0.3) to (+0.4), a unique phenomenon termed herein “Solvent split” takes place. This range is expected to be affected by the type of OWB or the presence of a hydrophobic solvent.

In one embodiment, the hydrophilic solvent has Log P(Octanol/water) has a value in the range of between (−0.3) to (+0.4). In some embodiments, the hydrophilic solvent is a solvent is selected from solvents having a Log P (octanol/water) lower than 1.5.

In another embodiment the solvent is a solvent with low boiling point such as ethanol, in another embodiment the selected solvent or solvents is a solvent with boiling point higher than 150° C., as will be known to the skilled artisan.

In some embodiments, the CO₂ pressure is higher than 1 atm, and in some embodiments, the CO₂ pressure is higher than 2 atm. In preferred further embodiment the CO₂ pressure is higher than 5 atm.

In one embodiment, the pK½ of the OWB is lower than 1.5 and in another embodiment, the pK½ of the OWB is lower than 1 and in a further embodiment, and the pK½ of the OWB is between 0 and 1.

In some embodiments, the OWB is an amine or comprises a Phosphor or Nitrogen or sulfur or a combination thereof and in some embodiments, the OWB is a branched tertiary amine, wherein in some embodiments, one or more of the chains of the organic tertiary amine is comprises 1 to 8 carbons and in some embodiments, one or more of the chains of the comprises a more complex side chain wherein the side chain is selected from isoprene, cyclic or aromatic compounds or other compounds of a complex nature.

In some embodiments, the OWB is tri ethyl hexyl amine and in some embodiments, OWB has lower molecular weight as compared to tri ethyl hexyl amine.

In some embodiments, the solution comprises a diluent, which in some embodiments is a hydrophobic solvent.

In some embodiments, the weight ratio between the hydrophilic solvent/s to the OWB, in the first liquid phase, is higher than 0.2 and in some embodiments, the weight ratio between the hydrophilic solvent/s to the OWB, in the first liquid phase, is higher than 0.25

In some embodiments, the concentration of salt of strong acid in the first liquid phase is at least 30% of its solubility limit concentration.

In some aspects, the hydrophilic solvent is selected from ethanol, 1-propanol, iso butanol or third butanol, esters, ethers, amides and polar solvents or a combination thereof.

In some embodiments, OWB is an amine comprising P or S or N or a combination thereof.

In some aspects, the OWB is a branched tertiary amine.

In some aspects, the OWB is tri ethyl hexyl amine.

In some aspects, the OWB has a lower molecular weight than tri ethyl hexyl amine. In some embodiments, one or more of the chains comprises a more complex side chain, such as, for example, wherein the side chain is selected from isoprene, cyclic or aromatic compound or other compounds of a complex nature.

### Separation of the Hydrophilic Solvent

One of the effects of the hydrophilic solvent is increasing the basicity of the OWB in the first liquid phase. In order to enable efficient release of the strong acid from the OWB, the hydrophilic solvent must be removed before the release of the strong acid.

In one embodiment, the hydrophilic solvent is removed by back extraction with water or aqueous solution. In another embodiment the back extraction is done at temperature higher than 40° C. and in another embodiment, the back extraction is done in a temperature higher than 80° C.

In one embodiment the hydrophilic solvent is removed by evaporation, or in another embodiment, the hydrophilic solvent is removed by extraction, or in another embodiment, the hydrophilic solvent is removed by split of the solution or in another embodiment, the hydrophilic solvent is removed by any combination thereof.

In a more preferred embodiment, the hydrophilic solvent is removed by splitting the first liquid phase into 2 liquid phases, the one comprises of most of the OWB*HX while the second comprises of the hydrophilic solvent, the salt of strong acid and water.

The split of hydrophilic using solvent split is intended to save costs. In the best cases, a small change in conditions causes a major separation effect. It was very surprisingly found that such an effect can be achieved in solutions comprising the hydrophilic solvent, OWB, strong acid, salt of strong acid and water for some hydrophilic solvents having a narrow range of Log P(octanol/water). For other hydrophilic solvents, out of this range, such phenomena of a small change in conditions causes a major separation effect does not take place.

In one embodiment the separation of the hydrophilic Solvent Split is accomplished via a method comprising effecting a change in temperature, such as by heating of the solution, addition of CO₂, including addition of liquid CO₂, addition of the salt of strong acid, addition of an hydrophobic solvent, addition of OWB, addition of a hydrophilic solvent, addition of water, addition of aqueous solution, removing of at least part of the hydrophilic solvent or a combination thereof.

In another embodiment the residual hydrophilic solvent is removed from the phase comprising OWB and acid, which in some embodiments, is accomplished by washing with water or an aqueous solution. In another embodiment the residual hydrophilic solvent is washed by the strong acid salt solution.

Separation of the Strong Acid from OWB*HX

In some embodiments, the processes of this invention include a step wherein the acid is removed from the phase comprising OWB by back extraction with water or aqueous solution comprising the salt of strong acid.

In some embodiments, the back extraction is performed at temperature higher than 40° C.

In some embodiments the acid is removed from the phase comprising OWB by thermal decomposing of the OWB*strong acid at a temperature higher than 100° C.

In another embodiment, the acid is removed from the phase comprising OWB by heating to a temperature of higher than 130° C.

In another embodiment, the acid is removed from the phase comprising OWB by contact with a base or a carbonate salt or a bicarbonate salt or a combination thereof.

In another embodiment, the acid is removed from the phase comprising OWB by contact with a salt of weak acid. In another embodiment the salt of a weak acid is selected from metal sulfide, metal bisulfide, phosphate ores, metal silicates

In one embodiment, the acid is removed from the phase comprising OWB by contact with a metal oxide or a metal hydroxide

In another embodiment, the acid is removed from the phase comprising OWB by contact water or aqueous solution comprises strong acid salt.

It will be appreciated by the skilled artisan that numerous methods are known in the field for the separation of the acid from the OWB, any of which can be applied herein even if not specifically described and same is to be considered as part of the contemplated process of this invention.

In some embodiments, the reaction is carried out continuously. In some embodiments, the method of the invention is carried out continuously. According to this aspect, and in some embodiments, the solution comprises also the strong acid (as OWB*HX) which has solubility higher than OWB itself in the solution, thus reducing the amount of solvent required to form a single liquid phase.

In another embodiment, the preferred solvent is selected from polar solvents with high solubility in water. In other embodiments, the hydrophilic solvent is DMSO, DMSO, methyl formamide or other hydrophilic polar solvents

The present invention also provides a method for separation of HCl from a CaCl₂ waste stream obtained in the mining industry while producing CaCO₃ and HCl that can be recycled to the ore-leaching step of that process or sold as HCl solution. In a similar way, the present invention can be used for separation of strong acids other than HCl from the mining industry thus recycling the strong acid to previous steps and producing carbonate, or bicarbonate salts or oxides.

In another embodiment, the cation in the strong acid salt is a divalent cation or a monovalent cation.

In a further embodiment the cation is a divalent cation and in a more preferred embodiment the cation is one of Ca or Mg or any combination thereof. In another embodiment the cation is a monovalent cation and in a further embodiment the cation is ammonium or sodium.

In one embodiment the strong acid is selected from HCl, halogenic acids, H₂SO₄, HNO₃, H₃PO₄.

In another embodiment the salt is CaCl₂ or MgCl₂.

In a further embodiment, OWB is organic weak base having pK½ lower than 1.5. In a more preferred embodiment the pK½ of the OWB is lower than 1. In another embodiment OWB is a branch tertiary amine. In a further embodiment the OWB is tri ethyl hexyl amine (TEHA). In a preferred embodiment the OWB is a branch tertiary amine having more complex side chains than in TEHA, such as propyl hexyl, butyl hexyl, penyl hexyl. In a preferred embodiment, the tertiary amine is more hydrophobic then TEHA.

As referred to herein, the “pK½₀” with respect to of the OWB is the pH measured at an aqueous phase that is in contact with the organic phase comprising the OWB at HCl to OWB molar ratio of 1

In another embodiment, the OWB comprises an element selected from C, P, O, N, S and the combination of.

In one embodiment, the solvent and water are removed in step (d) by cooling the solution to get a phase comprising most of the amine and the strong acid and a second liquid phase comprising most of the water, solvent, water, and most of the strong acid salt. In that embodiment at least part of that phase is recycled to (a).

In another embodiment, the solvent and water are removed in step (d) by evaporation or distillation. In another embodiment, the solvent is removed in step (d) by extraction of at least part of the hydrophilic solvent into a less hydrophilic solvent. According to this aspect and in a further embodiment, the resulting solvent-depleted solution is split into a phase comprising most of the solvent and water and another phase comprising most of the amine and strong acid.

In one embodiment the strong acid is separated from the amine by evaporation at temperature higher that 100° C., or in another embodiment, at a temperature higher than 120° C.

In another embodiment the strong acid is separated from the amine by back-extraction into an aqueous solution. In another embodiment, the back-extraction is performed at a temperature higher than 50° C. In another embodiment, the back extraction is performed at a temperature higher than 70° C.

Type and Origin of the Salt of a Strong Acid

The methods and processes of this invention can find application with any source comprising a salt of strong acid.

Certain embodied groups of processes from various fields are described herein, however, it will be evident to the skilled artisan that the applications mentioned here are only a part of optional applications and the invention is not to be considered limited to same alone.

### Reducing the Amount of Waste and of the Raw Materials in the Mining Industry and in Fly-Ash Treatment

Many processes for the production of metals and salts in the mining industry require a step of leaching. In this step, a strong acid is added to produce salts of the strong acid of the leached cation. After the extraction of the desired cation, the remaining solution comprises a variety of salts of the strong acids and the free strong acid. The cost of dealing with the waste solutions is high. In addition, many of the cations are poisonous and are not allowed to be disposed of, in the absence of appropriate treatment. It is therefore a goal to find methods to reduce the amount of waste coming from the mining industry.

After the extraction of most of the four-valent and three-valent cations, the remaining divalent solution comprises free strong acids, traces of 3 and 4 valent cations, divalent cations and mono-valent cations. The present invention provides a method for extracting the strong acid from the strong acid salts present in this solution.

### Pre-Treatment of the Divalent Cations Entering the Process:

In one embodiment, the pH of the remaining divalent cation solution is increased to precipitate the four valent and three valent cations. In another embodiment the increase in pH is done by adding a divalent cation carbonate to the solution. In another embodiment, the temperature of the precipitation solution is increased. In a preferred solution, the addition of the base and or the divalent carbonate salt is controlled by pH-meter to separate the various cations by pH effect.

Some divalent cations can precipitate as the cation hydroxides. Others can be precipitated, according to the present invention as the divalent cations carbonate. Others can be precipitated as either hydroxides or carbonates. Since the purity of the precipit5ated di-valent carbonate is a major factor in its price and the ability of selling it, it is an aim of this invention to get this product at the highest purity possible.

In one embodiment, the pH of the divalent cation solution is increase to precipitate cations oxides. In another embodiment, the cations oxides are fractionized according to their basicity to give fractions rich in specific cations.

In another embodiment, the remaining divalent cations are fractionized by adding CO2, in the present of OWB, as their carbonate salt. The fractionation is done according to their solubility in the first liquid phase of claim 1 of the present invention and their concentration in that phase. In another embodiment the solution of the divalent cations of highest concentration is purified to give high purity solution before entering the carbonate precipitation stage.

In a further embodiment, the strong acid salt is in a waste solution originated from the mining industry, in the production of a four valent cation oxides or hydroxide or metal or any combination thereof, or in the production of a three valent cation oxides or hydroxide or metal or any combination thereof.

In another embodiment, the divalent rich solution comes from leaching of ores rich in 4-valent cations. In a further embodiment, the four-valent cation are selected from ores comprising of titanium or zirconium, tin.

In another embodiment, the pH of the waste solution is increased to precipitate the residual 4-valent and residual 3-valent cations and part of the divalent cations as hydroxides or oxides

In a further embodiment, the pH is increased gradually to produce several precipitates precipitated at certain pH level, thus producing products comprising fractions of desired cation oxide.

In one embodiment, the divalent rich solution comes from leaching of ores rich in three-valent cations. In another embodiment, the three-valent cation is selected from ores comprising of aluminum, iron, and chrome.

In another embodiment, the ore comprising four- and/or tri-valent cation is rich also with a divalent cation. In a still further embodiment, the divalent cation is selected from Calcium or magnesium or a combination thereof.

In a further embodiment, the ore comprises oxides of cations, silicates of the cations or any combination thereof.

### Treatment of Fly-Ash Treatment

Fly-ash is solid particles obtained by burning of organic material. The 2 largest sources of fly ash are from burning of fuel and from burning of garbage and other waste streams. The fly-ash comprises of a mix of inorganic materials, a significant part is in the form of oxides but they contain also other anions such chloride and Sulfur comprising solids and silicates. Due to the high temperature treatment, the fly ash comprises monovalent bases and divalent bases in the form of oxides/hydroxides.

There is a regulative order that leads to an urgent need to reduce the volume of the fly ash to be buried and to remove dangerous soluble poisonous cations from it. One option to reduce the volume is to leach the solids in HCl, thus dissolving the mono-valent cations and the di-valent cations.

The cost of the consumed HCl is very high and therefore there is a need for a process to regenerate the acid. The present invention fulfills this task.

In one embodiment, the fly ash is washed with water to dissolve the mono-valent basic oxides to form basic hydroxides and also part of the divalent oxides. In another embodiment, the washing procedure is done at 50° C.-100° C.

In a further embodiment, the washed solid is leached with a strong acid solution to dissolve the divalent cations and a small part of the tri and four valent cations.

In another embodiment, the solids are leached with a strong acid, at higher temperature and concentration to dissolve also a larger part of the tri and four-valent cation.

In another embodiment, the suspension is filtered to get the unbleached solids and solution comprising the leached cations.

In another embodiment, a base or a carbonate is added to precipitate the four-valent and tri-valent cations. In another preferred embodiment, the base or the carbonate salt are added gradually to precipitate gradually the cations thus getting fractions of solids comprising mainly the desired cation oxides.

In another embodiment, the addition of the base or carbonate salt is stopped before precipitating the larger amount of the divalent-cation salt.

In another embodiment the solution comprising the divalent cation salts is added as the feed for the reaction mixture in step (b) of claim 1.

In another embodiment, the divalent cation carbonate obtained in step (c) of claim 1 is used to increase the pH of the leaching solution.

In another embodiment, the divalent-cation carbonate is CaCO₃ or MgCO₃ or any combination thereof.

In a further embodiment, the strong acid is HCl.

In another embodiment, the solids obtained after washing the mono-valent cations are treated with an ammonium salt. In one embodiment the salt is ammonium chloride. In another embodiment, the salt is ammonium salt of a weaker acid.

In the above step, the ammonium salt reacts with the divalent cation oxides present in the solids to produce ammonia and the salt of the divalent cation.

In one embodiment, the ammonia released, by contacting the ammonium salt with the solids, as described, is used to back-extract, at least a part of acid from the OWB in step (e) of the described process herein.

In one embodiment, the resulting ammonium salt is reacted, as described, with the divalent cation oxides present in the solids.

Biotechnology Industry

In one embodiment, the strong acid salt is obtained by adding a strong acid to a fermentation broth comprising a salt of a divalent-cation salt of organic acid. In another embodiment the organic acid is produced using a fermentation process. In a further embodiment the organic acid is Lactic acid and the salt is Ca-lactate. In another embodiment, the lactic acid is extracted from the resulting solution. In another embodiment, the resulting CaCl2 solution enters to the reaction described in claim 1 step (b) to give free HCl and CaCO3. In a further embodiment, the CaCO3 is added to the fermentation process to react with the produced organic acid.

In another embodiment, the strong acid is citric acid. In a further embodiment the citric acid is produced by fermentation. In another embodiment, citric acid is extracted from the fermentation broth and back-extracted to get citric acid solution. In another embodiment, citric acid is crystallized and recrystallized to get pure citric acid. In a further embodiment a strong acid is added to the mother liquor from ae crystallization or re-crystallization stage, to precipitate citric acid. In a further embodiment, the resulting CaCl2 solution is fed into the 3 reaction mixture in step (b) of the processes as herein described. In additional embodiments, the solution obtained after the crystallization of CaCO3 in the described process is separated from the hydrophilic solvent and the remaining citric acid solution is returned to the citric acid crystallization steps.

In another embodiment the organic acid is selected from any organic acid that is produced in a fermentation process.

Global Warming Solutions

There is an urgent need to find a process for capturing CO₂ and fixing it as a bicarbonate or a carbonate salt. The main difficulty is that due to the enormous volume of CO₂ released, the cost of the process should be very low. The meaning is that the raw materials must be abundant and cheap.

The most abundant cations that can form a carbonate or bicarbonate salts are Sodium, Calcium and Magnesium, but other mono-valent and divalent cations may be found in waste obtained in various waste streams and therefore be used in accordance with the present invention.

NaCl is one of the most abundant mono-valent cations. It is very accessible in sea water.

Water desalination processes are very efficient and cost-effective. The cost of producing 1 m³.water from sea water is in the range of less than 1$/m3. Concentration of the sea water to get high NaCl concentration is expected to be higher. Further concentration of the brine obtained after water desalination is much cheaper.

The reaction of CO₂ with NaCl must be aided by adding a medium-base extractant. The reaction is:

NaCl+H₂O+CO₂+MBE===MBE*HCl+NaHCO₃. Eq. 1.

MBE=Medium base extractant.

In order for the reaction to be completed, the HCl should be released from MBE, so that MBE will return to Eq. 1.

There are two types of reactants that can readily react with MBA*HCl, meaning oxides or carbonates of divalent cations. The products of the two reactions are the divalent cation chloride salts -MCl₂. In the case of HCl, the reaction will be

MBE*HCl+CaCO₃===MBE+CaCl₂ Eq. 2.

MBA is returned to the reaction in Eq. 1 and the product, MCl2 may be discarded as a waste stream or enter step (b) of claim 1. In the case of the second option, the total reaction are NaHCO₃+HCl as described in Eq. 3

NaCl+CO₂+H2O======NaHCO₃+HCl Eq. 3

Both products are of industrial interest and might be sold to cover the production costs. The CaCO₃ stream that is used in Eq. 1 might be or CaCO₃ comprising ores or the CaCO₃ product in claim 1.

In the case, in which CaO is used (Limestone ores), the HCl that is produced might react with limestone in situ so there are no mining costs.

The product NaHCO₃ may be used as CO₂ source for algae growth to produce food products or be fed to animals, fish and other leaving creatures. The resulting products might be uses as food or feed or for the production of valuable products such protein or from other hand for the production of fuel such in the case of biodiesel.

NHCO3 might also be heated to produce pure CO₂ to feed step (c) of a process as herein described. The product of that heating might be used to capture more CO₂ from the atmosphere.

In other embodiments, CO₂ is assimilated by
1. Reacting CaO with HCl obtained in step (e) of the described processes herein;
2. Separation of the resulting solution from the unreacted solids.
   3. Introducing the resulting solution comprising the salt of strong acid into the solution of step (a) of the described processes herein.

### EXAMPLES

### Example 1: Separation of HCl from its Salt in a Solution Comprising MgCl₂

Procedure

A solution comprising 72.2 wt % 1-propanol, 21.8% TEHA (Tri ethyl hexyl amine) and 6 wt % of 50 wt % MgCl₂ aqueous solution was stirred at RT in a closed vessel. CO₂ at a pressure of 2 bar was introduced into the solution. After 1 hour, the crystals were filtered and the solution was titrated for acid content. (TEHA is an OWB)

Results

The molar ratio between the acid and the amine is 0.85.

### Example 2: Separation of HCl from NaCl Solution Using TOA as the OWB

Procedure

A solution comprising 62 wt % Iso-propanol, 15.1% TOA (Tri octyl amine) (TOA organic base that is much stronger then TEHA) and 62.9 gr of 13 wt % NaCl aqueous solution was stirred at RT in open vessel. CO₂ was bubbled into the solution. After 1 hour, the crystals were filtered and the solution was titrated for acid content.

Results

The molar ratio between the acid and the amine is 0.85

In the case of TOA which is a much stronger base than TEHA, HCl can be separated from NaCl solution

### Example 3: Separation of HCl from its Salt in a Solution Comprising CaCl2

Procedure

A solution comprising 72.2 wt % 1-propanol, 21.8% TEHA (Tri ethyl hexyl amine) and 6 wt % of 50 wt % MgCl2 aqueous solution was stirred at RT in a closed vessel.

CO₂ at a pressure of 2 bar was introduced into the solution. After 1 hour, the crystals were filtered and the solution was titrated for acid content.

Results

| [CaCl2] | % CaCl2 | | % solvent | % TEHA | CO₂ | Z Mole |
|---|---|---|---|---|---|---|
| Wt % in | in final | | in final | in final | Pressure | HCl/mole |
| water | solution | Solvent | solution | solution | bar | Amine |
| 40 | 6.1 | Iso PrOH | 80.4 | 13.5 | Bubbling for 2 | 0.55 |
| | | | | | hours | |
| 40 | 6.1 | Iso PrOH | 81.5 | 12.4 | Bubbling for 2 | 0.58 |
| | | | | | hours | |
| 37 | 7.1 | Iso PrOH | 79.7 | 13.2 | 2 | 0.7 |
| 37 | 10.3 | Ethanol | 68.9 | 20.8 | 2 | 0.46 |
| 37 | 3.5 | butanol | 75.4 | 21.1 | 2 | 0.25 |
| 37 | 3.2 | Tert butanol | 73.4 | 23.4 | 2 | 0.22 |
| 37 | 1.4 | Tert butanol | 82.6 | 16 | 2 | 0.26 |
| 37 | 2.8 | 1 propanol | 75.5 | 21.7 | 2 | 0.56 |
| 50 | 6.4 | 1 propanol | 57.2 | 36.4 | 2 | 0.27 |
| 24 | Separate | No solvent | 0 | 100 | 7 | (2 liquid |
| | aqueous phase | | | | | phases) |
| 24 | Separate | octanol | 50 | 50 | 7 | (2 liquid |
| | aqueous phase | | | | | phases) |
| 24 | Separate | octanol | 78 | 22 | 7 | 2 liquid |
| | aqueous phase | | | | | phases) |

Z = the molar ratio between HCl to the amine

Conclusion

In a case in which there is a solution comprising TEHA (the OWB), solvent and the salt with no or with insignificant presence of a second phase, HCl was released from the salt and CaCO₃ was produced. The reaction was efficient even when CO₂ was bubbled to the solution in an open vessel.

In the case of octanol as the solvent, 2 liquid phases are formed and there is practically no CaCl2 in the solvent phase. In this case even at 7 bar of CO₂ and high solvent content, HCl was not separated from its salt and no CaCO₃ was formed.

### Example 5 the Effect of Presence of a Second Liquid Phase

In most cases in this experiment the solvent is 1-PrOH. (Some of the experiments that are presented in this table are also presented in Experiments 1 and/or 2).

| [CaCl2] | % CaCl2 | | % solvent | % TEHA | CO₂ | Z Mole | |
|---|---|---|---|---|---|---|---|
| Wt % in | In final | | in final | in final | Pressure | HCl/mole | No of liquid |
| water | solution | Solvent | solution | solution | bar | Amine | phases |
| 40 | 10.8 | 1-PrOH | 81.5 | 12.4 | 35 | 0.86 | 1 |
| 50 | 8.1 | 1-PrOH | 80.4 | 31 | 2 | 0.75 | 1 |
| 37 | 2.8 | 1-PrOH | 75.5 | 21.7 | 2 | 0.56 | |

Conclusions

The loading of the amine (Z) increases with the increase of the CaCl2 concentration in reaction solution.

### Experiment 6. Separation of HCl from CaCl2 and Release of HCl from the OWB

Using TOA as the OWB,

Comparative Experiment 6.1. No solvent

Procedure

5 gr, 27% CaCl2 solution and 5 gr TOA (Tri octyl amine) were added into a vessel. No solvent was added and 2 liquid phases were present. The solution was stirred at RT in a closed vessel. CO₂ at a pressure of 7 bar. was introduced into the solution. After 1 hour, the crystals were filtered and the solution was titrated for acid content.

Result: Z=0.36

Comparative Experiment 6.2.

TOA (Tri-octyl amine) as the Organic base ethanol as the solvent, P-CO₂=2 bar.

Procedure: The procedure is similar to that in Experiment 6.1. but with ethanol as the solvent. A single liquid phase was present and CaCO₃ crystals were formed.

Results: Z=1

Step 2: Back extraction

9 gr of the upper phase was introduced into a vial. The solution was stripped at 60 C, to remove all of the ethanol.

10 gr water is added into the vial and the solutions are stirred at RT for 30 min. a sample from the aqueous phase was analyzed for acidity.

Result: The concentration of HCl in the aqueous phase is 0.18 wt %.

Conclusions:

The acid could not be back extracted to give reasonable concentration.

Experiment 6.2 TEHA as OWB, 1-propanol as the solvent.

Step 2 Back-Extraction

9 gr of the upper phase obtained in the solution of Experiment 4.1 was introduced into a vial. The solution was stripped at 60 C, to remove all of the solvent.

10 gr water is added into the vial and the solutions are stirred at RT for 30 min. a sample from the aqueous phase was analyzed for acidity.

Result: The concentration of HCl in the aqueous phase is 6 wt %.

Conclusions: The HCl that was separated from CaCl2, using TEHA in a single phase, could be back-washed to give an aqueous solution of 6 wt %.

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

1. A process for the recovery of a strong acid from its salt with divalent cation comprising:
a) Preparing a reaction mixture comprising a first liquid phase comprising of (a) at least one organic weak base (OWB), (b) at least one hydrophilic solvent and (c) a salt of a strong acid.
b) Adding C02 into said solution inducing the precipitation of carbonate salt or bicarbonate salt or the combination of
c) Removing of at least part of the resulting suspension comprising the liquid phase and separation of the precipitated carbonate salt, to get the resulting solution and the carbonate salt or the bicarbonate salt.
d) Separation of the hydrophilic solvent from said resulting solution and recycling of the hydrophilic solvent to step 1.
e) Separation of the strong acid from the OWB and recycling the OWB to step 1.

2-61. (canceled)
